(19) United States
(12) Patent Application Publication
(10) Pub. No.: US 2023/0379250 A1
(43) Pub. Date: Nov. 23, 2023

(54) FORWARDING DECISIONS BASED ON HEADER COMPRESSION IN INDUSTRIAL NETWORKS

(71) Applicant: Cisco Technology, Inc., San Jose, CA (US)

(72) Inventors: Pascal Thubert, Roquefort les Pins (FR); Patrick WETTERWALD, Mouans Sartoux (FR); Eric LEVY-ABEGNOLI, Valbonne (FR); Jonas ZADDACH, Antibes (FR)

(21) Appl. No.: 17/750,215

(22) Filed: May 20, 2022

(51) Int. Cl. H04L 45/745; H04L 45/00; H04L 45/42; H04L 43/106

(52) U.S. Cl. CPC H04L 45/745; H04L 45/566; H04L 45/42; H04L 43/106

(57) ABSTRACT

In one embodiment, an illustrative method herein may comprise: receiving, at an access device for a network, a packet having a set of packet features; making, by the access device, a determination that the set of packet features of the packet match a forwarding ruleset that defines differentiated services for different types of packets based on their packet features; formulating, by the access device and based on the determination, a compressed header for the packet that has one or more differentiated service indicators based on the forwarding ruleset; and forwarding, from the access device, the packet with the compressed header, to cause forwarding decisions to be made within the network for the packet based on the one or more differentiated service indicators in its compressed header.

### TECHNICAL FIELD

The present disclosure relates generally to computer networks, and, more particularly, to forwarding decisions based on header compression in industrial networks.

### BACKGROUND

The Internet of Things, or “IoT” for short, represents an evolution of computer networks that seeks to connect many everyday objects to the Internet. Notably, there has been a recent proliferation of ‘smart’ devices that are Internet-capable such as thermostats, lighting, televisions, cameras, and the like. In many implementations, these devices may also communicate with one another. For example, an IoT motion sensor may communicate with one or more smart lightbulbs, to actuate the lighting in a room when a person enters the room. Vehicles are another class of ‘things’ that are being connected via the IoT for purposes of sharing sensor data, implementing self-driving capabilities, monitoring, and the like.

One type of IoT network is an Operational Technology (OT) network (e.g., an industrial control systems environment), where hardware and software are provided that detect or cause a change, through the direct monitoring and/or control of industrial equipment, assets, processes, and events.

The nature of the IoT makes network security (and forwarding) particularly challenging, especially in the case of industrial settings, such as factories, mines, ports, power substations, and the like.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example network;

FIG. 2 illustrates an example network device/node;

FIG. 3 illustrates an example network architecture for an industrial network;

FIGS. 4A-4B illustrate example displays of component and activity tags;

FIG. 5 illustrates an example display of an asset profile;

FIG. 6 illustrates an example of an industrial/operational technology (OT) network;

FIGS. 7A-7B illustrate an example of an operation enabling forwarding decisions based on header compression in industrial networks; and

FIG. 8 illustrates an example simplified procedure for enabling forwarding decisions based on header compression in industrial networks.

### DESCRIPTION OF EXAMPLE EMBODIMENTS

### Overview

According to one or more embodiments of the disclosure, an illustrative method herein may comprise: receiving, at an access device for a network, a packet having a set of packet features; making, by the access device, a determination that the set of packet features of the packet match a forwarding ruleset that defines differentiated services for different types of packets based on their packet features; formulating, by the access device and based on the determination, a compressed header for the packet that has one or more differentiated service indicators based on the forwarding ruleset; and forwarding, from the access device, the packet with the compressed header, to cause forwarding decisions to be made within the network for the packet based on the one or more differentiated service indicators in its compressed header.

In one embodiment, the method further comprises: making, by the access device, a negative determination that the set of packet features of the packet does not match the forwarding ruleset; and sending, by the access device and based on the negative determination, the packet to a network controller for further examination.

In still another embodiment, the network controller validates the packet and forwards the packet through the network towards a destination, and the method further comprises: receiving, from the network controller, an update for the forwarding ruleset to include the set of packet features of the packet that did not match the forwarding ruleset.

Other embodiments are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others. The Internet is an example of a WAN that connects disparate networks throughout the world, providing global communication between nodes on various networks.

The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or power-line communication (PLC) networks. That is, in addition to one or more sensors, each sensor device (node) in a sensor network may generally be equipped with a radio transceiver or other communication port, a microcontroller, and an energy source, such as a battery. Often, smart object networks are considered field area networks (FANs), neighborhood area networks (NANs), etc. Generally, size and cost constraints on smart object nodes (e.g., sensors) result in corresponding constraints on resources such as energy, memory, computational speed and bandwidth.

Networks may also be, or may include, an “Internet of Things” or “IoT” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid, smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

One type of IoT network is an Operational Technology (OT) network (e.g., an industrial control systems environment), where hardware and software are provided that detect or cause a change, through the direct monitoring and/or control of industrial equipment, assets, processes, and events.

Often, IoT networks operate within a shared-media mesh network, such as wireless or PLC networks, etc., and are often on what is referred to as Low-Power and Lossy Networks (LLNs), which are a class of networks in which both the routers and their interconnects are constrained. That is, LLN devices/routers typically operate with constraints, e.g., processing power, memory, and/or energy (battery), and their interconnects are characterized by, illustratively, high loss rates, high bit error rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Fog computing is a distributed approach of cloud implementation that acts as an intermediate layer or hierarchy of layers from local networks (e.g., IoT networks) to the cloud (e.g., centralized and/or shared resources, as will be understood by those skilled in the art). That is, generally, fog computing entails using devices at the network edge to provide application services, including computation, networking, and storage, in close proximity to the local nodes in the network, in contrast to cloud-based approaches that rely on remote data centers/cloud environments for the services. To this end, a fog node is a functional node that is deployed close to IoT endpoints to provide computing, storage, and networking resources and services. Multiple fog nodes organized or configured together form a fog system, to implement a particular solution. Fog nodes and fog systems can have the same or complementary capabilities, in various implementations. That is, each individual fog node does not have to implement the entire spectrum of capabilities. Instead, the fog capabilities may be distributed across multiple peer-to-peer and hierarchical layers of fog nodes and systems, which may collaborate to help each other to provide the desired services. In other words, a fog system can include any number of virtualized services and/or data stores that are spread across the distributed fog nodes. This may include a master-slave configuration, publish-subscribe configuration, or peer-to-peer configuration.

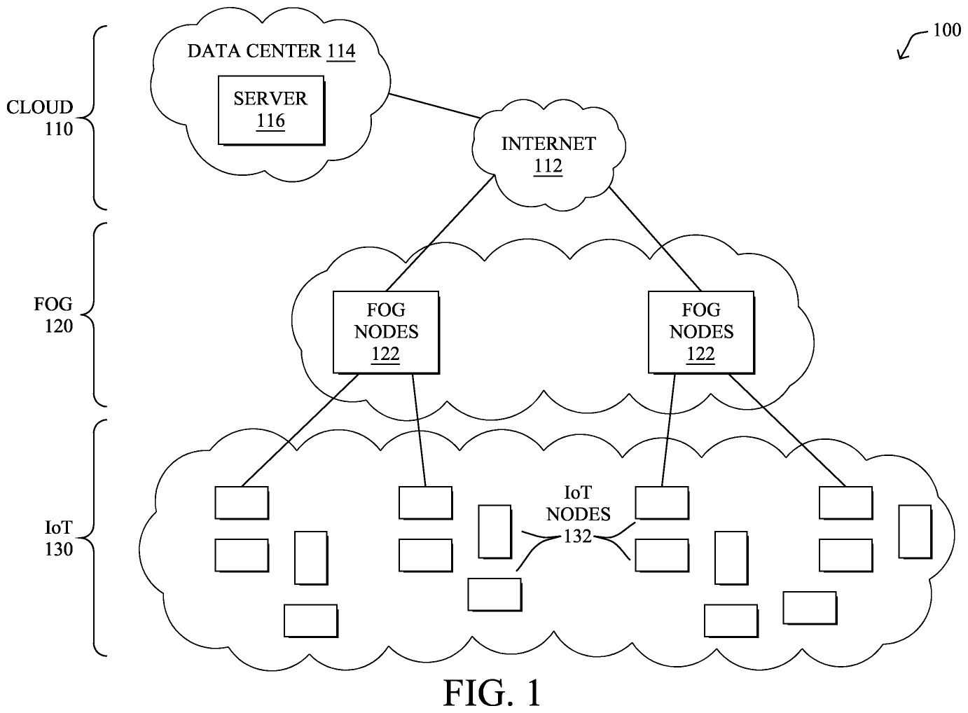

FIG. 1 is a schematic block diagram of an example simplified computer network 100 illustratively comprising nodes/devices at various levels of the network, interconnected by various methods of communication. For instance, the links may be wired links or shared media (e.g., wireless links, PLC links, etc.) where certain nodes, such as, e.g., routers, sensors, computers, etc., may be in communication with other devices, e.g., based on connectivity, distance, signal strength, current operational status, location, etc.

Specifically, as shown in the example network 100, three illustrative layers are shown, namely the cloud 110, fog layer 120, and IoT layer 130. Illustratively, the cloud 110 may comprise general connectivity via the Internet 112, and may contain one or more datacenters 114 with one or more centralized servers 116 or other devices, as will be appreciated by those skilled in the art. Within the fog layer 120, various fog nodes/devices 122 may execute various fog computing resources on network edge devices, as opposed to datacenter/cloud-based servers or on the endpoint nodes 132 themselves of the IoT layer 130. Data packets (e.g., traffic and/or messages sent between the devices/nodes) may be exchanged among the nodes/devices of the computer network 100 using predefined network communication protocols such as certain known wired protocols, wireless protocols, PLC protocols, or other shared-media protocols where appropriate. In this context, a protocol consists of a set of rules defining how the nodes interact with each other.

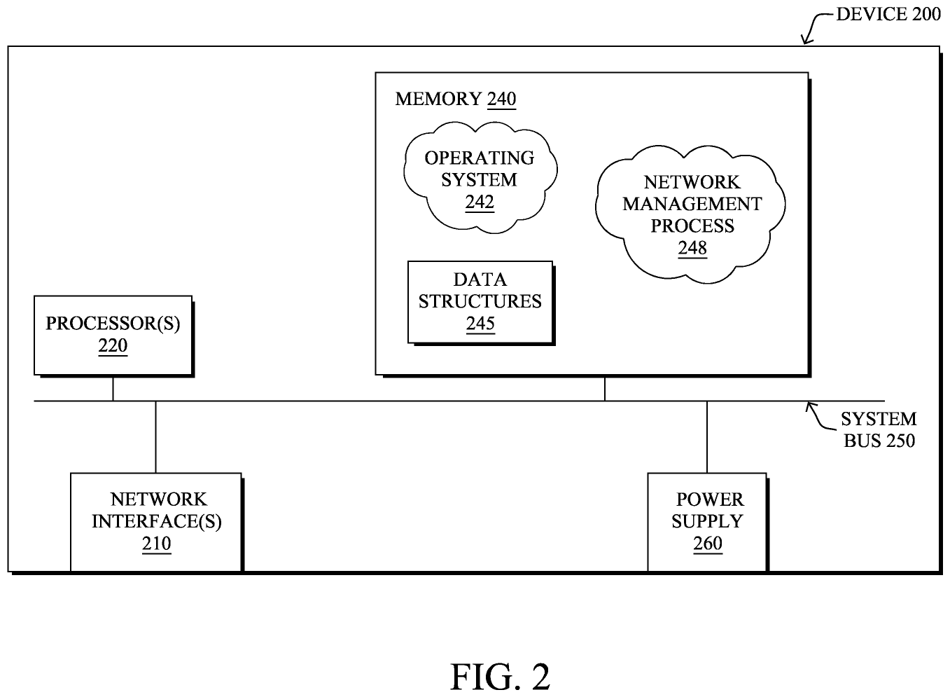

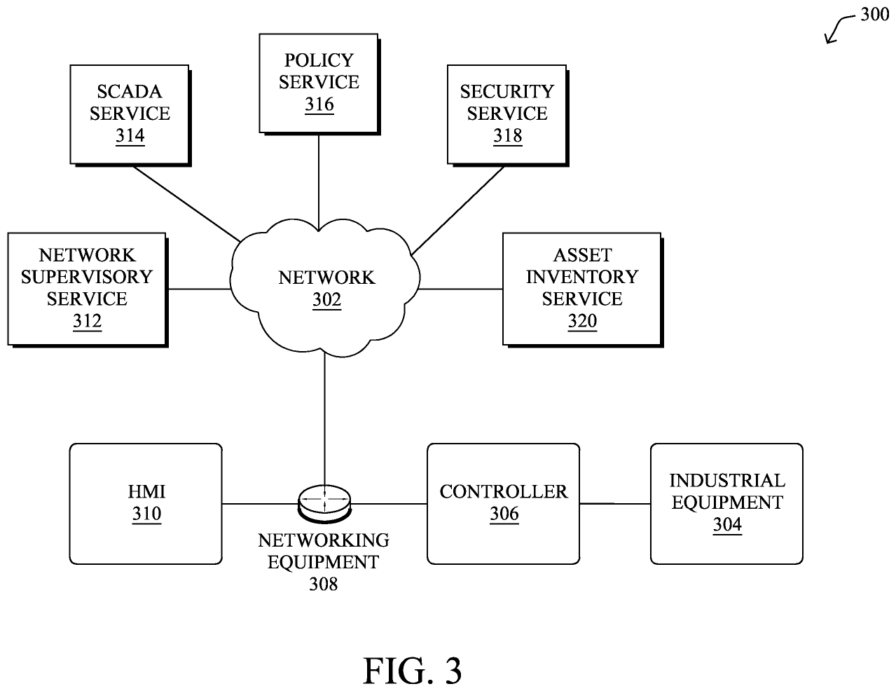

FIG. 2 is a schematic block diagram of an example node/device 200 that may be used with one or more embodiments described herein, e.g., as any of the nodes/devices shown in FIG. 1 above (or FIG. 3, below). The device may comprise one or more network interfaces 210 (e.g., wired, wireless, power-line communication (PLC), etc.), at least one processor 220, and a memory 240 interconnected by a system bus 250, as well as a power supply 260 (e.g., battery, plug-in, etc.).

Network interface(s) 210 include the mechanical, electrical, and signaling circuitry for communicating data over links coupled to the network. The network interfaces 210 may be configured to transmit and/or receive data using a variety of different communication protocols, such as TCP/IP, UDP, etc. Note that the device 200 may have multiple different types of network connections (interfaces 210), e.g., wireless and wired/physical connections, and that the view herein is merely for illustration. Also, while the network interface 210 is shown separately from power supply 260, for PLC the network interface 210 may communicate through the power supply 260, or may be an integral component of the power supply. In some specific configurations the PLC signal may be coupled to the power line feeding into the power supply.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes/services may comprise a forwarding process 244 and an illustrative “header compression” process 248, as described herein. Note that while processes 244 and 248 are shown in centralized memory 240 alternative embodiments provide for the process to be specifically operated within the network interface(s) 210.

Generally, forwarding process 244 includes computer executable instructions executed by processor 220 to perform functions provided by one or more forwarding protocols, routing protocols, industrial automation protocols, etc., as will be understood by those skilled in the art. These functions may be configured to manage forwarding decisions on packets, frames, data, etc., using various rules, procedures, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

In general, network security services within a computer network may be configured to perform any or all of the following tasks:
1. Identifying and classifying devices in the network—this may entail, for example, determining the make, model, software configuration, type, etc. of a given device.
2. Discerning operational insights about a device—for example, network security processes may assess the traffic of a particular device, to determine what the device is doing, or attempting to do, via the network. Such information may take the form of device details and communication maps for the device. In further cases, the device functions and application flows may be converted into tags and/or events for presentation to a user interface. Further, network security processes may also track variable changes, to monitor the integrity of the industrial workflow.
3.Detecting anomalies—network security processes may also assess the behaviors of a device on the network, to determine whether its behaviors are anomalous. In various embodiments, this may entail network security processes determining whether the behavior of the device has changed significantly over time and/or does not fit the expected behavioral pattern for its classification. For example, if the device is identifies as being a temperature sensor that periodically sends temperature measurements to a supervisory service, but the device is instead communicating data elsewhere, network security processes may deem this behavior anomalous.

In various embodiments, network security processes herein may employ any number of machine learning (ML) and/or artificial intelligence (AI) techniques, to assess the gathered telemetry data regarding the traffic of the device. In general, machine learning is concerned with the design and the development of techniques that receive empirical data as input (e.g., telemetry data regarding traffic in the network) and recognize complex patterns in the input data. For example, some machine learning techniques use an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function is a function of the number of misclassified points. The learning process then operates by adjusting the parameters a,b,c such that the number of misclassified points is minimal. After this optimization/learning phase, network security processes can use the model M to classify new data points, such as information regarding new traffic flows in the network. Often, M is a statistical model, and the cost function is inversely proportional to the likelihood of M, given the input data.

In various embodiments, network security processes may employ one or more supervised, unsupervised, or semi-supervised machine learning models. Generally, supervised learning entails the use of a training set of data, as noted above, that is used to train the model to apply labels to the input data. For example, the training data may include sample telemetry data that is “normal,” or “suspicious.” On the other end of the spectrum are unsupervised techniques that do not require a training set of labels. Notably, while a supervised learning model may look for previously seen attack patterns that have been labeled as such, an unsupervised model may instead look to whether there are sudden changes in the behavior of the network traffic. Semi-supervised learning models take a middle ground approach that uses a greatly reduced set of labeled training data.

Example machine learning techniques that network security processes can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) ANNs (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of traffic flows that are incorrectly classified as malware-generated, anomalous, etc. Conversely, the false negatives of the model may refer to the number of traffic flows that the model incorrectly classifies as normal, when actually malware-generated, anomalous, etc. True negatives and positives may refer to the number of traffic flows that the model correctly classifies as normal or malware-generated, etc., respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

In some cases, network security processes may assess the captured telemetry data on a per-flow basis. In other embodiments, network security processes may assess telemetry data for a plurality of traffic flows based on any number of different conditions. For example, traffic flows may be grouped based on their sources, destinations, temporal characteristics (e.g., flows that occur around the same time, etc.), combinations thereof, or based on any other set of flow characteristics.

Notably, certain aspects of the techniques herein may be based on approaches to tag assets/devices in a network based on their telemetry data. In some aspects, this tagging can be used to drive network policy enforcement regarding the assets.

For example, FIG. 3 illustrates an example network architecture 300 for an industrial network, according to various embodiments. As shown, architecture 300 may include industrial equipment 304 connected to a controller 306, such as a programmable logic controllers (PLC), a variable frequency drive (VFD), or the like, that controls the operations of industrial equipment 304. In turn, controller 306 for industrial equipment 304 may be connected to a human-machine interface (HMI) 310 via networking equipment 308, allowing a human user to interface with it (e.g., to visualize the industrial process, issue commands, etc.). In addition, networking equipment 308 may also provide connectivity via the greater network 302 to any number of network services 312-320 provided in the local network of networking equipment 308 and/or remotely. For example, services 312-320 may be implemented in the local network via dedicated equipment or virtualized across any number of devices (e.g., networking equipment 308). In other cases, services 312-320 may be provided by servers in a remote data center, the cloud, or the like.

As would be appreciated, industrial equipment 304 may differ, depending on the industrial setting in which architecture 300 is implemented. In many cases, industrial equipment 304 may comprise an actuator such as, but not limited to, a motor, a pump, a solenoid, or the like. In other cases, industrial equipment 304 may include a circuit and controller 306 may control the powering of the circuit.

Industrial equipment 304 may also include any number of sensors configured to take measurements regarding the physical process implemented by industrial equipment 304. For example, such sensors may take temperature readings, distance measurements, humidity readings, voltage or amperage measurements, or the like, and provide them to controller 306 for industrial equipment 304. During operation, controller 306 may use the sensor data from industrial equipment 304 as part of a control loop, thereby allowing controller 306 to adjust the industrial process as needed.

HMI 310 may include a dedicated touch screen display or may take the form of a workstation, portable tablet or other handheld, or the like. Thus, during operation, visualization data may be provided to HMI 310 regarding the industrial process performed by industrial equipment 304. For example, such visualizations may include a graphical representation of the industrial process (e.g., the filling of a tank, etc.), the sensor data from industrial equipment 304, the control parameter values used by controller 306, or the like. In some embodiments, HMI 310 may also allow for the reconfiguration of controller 306, such as by adjusting its control parameters for industrial equipment 304 (e.g., to shut down the industrial process, etc.).

Networking equipment 308 may include any number of switches, routers, firewalls, telemetry exporters and/or collectors, gateways, bridges, and the like. In some embodiments, these networking functions may be performed in a virtualized/containerized manner. For example, a telemetry exporter may take the form of a containerized application installed to networking equipment 308, to collect and export telemetry regarding the operation networking equipment 308 (e.g., queue state information, memory or processor resource utilization, etc.) and/or network 302 (e.g., measured delays, drops, jitter, etc.).

In some embodiments, at least a portion of network 302 may be implemented as a software-defined network (SDN). In such implementations, control plane decisions by the networking equipment of network 302, such as networking equipment 308, may be centralized with an SDN controller. For example, rather than networking equipment 308 establishing routing paths and making other control decisions, individually, such decisions can be centralized with an SDN controller (e.g., network supervisory service 312, etc.).

During operation, network supervisory service 312 may function to monitor the status and health of network 302 and networking equipment 308. An example of such a network supervisory service is DNA-Center by Cisco Systems, Inc. For example, in some implementations, network supervisory service 312 may take the form of a network assurance service that assesses the health of network 302 and networking equipment 308 through the use of heuristics, rules, and/or machine learning models. In some cases, this monitoring can also be predictive in nature, allowing network supervisory service 312 to predict failures and other network conditions before they actually occur. In either case, network supervisory service 312 may also provide control over network 302, such as by reconfiguring networking equipment 308, adjusting routing in network 302, and the like. As noted above, network supervisory service 312 may also function as an SDN controller for networking equipment 308, in some embodiments.

As shown, architecture 300 may also include supervisory control and data acquisition (SCADA) service 314 which supervises the operation of the industrial process. More specifically, SCADA service 314 may communicate with controller 306, to receive data regarding the industrial process (e.g., sensor data from industrial equipment 304, etc.) and provide control over controller 306, such as by pushing new control routines, software updates, and the like, to controller 306.

As would be appreciated, SCADA service 314, controller 306, and/or HMI 310 may communicate using an automation protocol. Examples of such protocols may include, but are not limited to, Profibus, Modbus, DeviceNet, HART, DNP3, IEC 61850, IEC 60870-5, and the like. In addition, different protocols may be used within network 102 and among networking equipment 308, depending on the specific implementation of architecture 300. Further, different portions of network 302 may be organized into different cells or other segmented areas that are distinct from one another and interlinked via networking equipment 308.

Architecture 300 may also include a policy service 316 that is responsible for creating and managing security and access policies for endpoints in network 302. An example of such a policy service 316 is the Identity Services Engine (ISE) by Cisco Systems, Inc. In various embodiments, as detailed below, policy service 316 may also be configured to identify the types of endpoints present in network 302 (e.g., HMI 310, controller 306, etc.) and their corresponding actions/functions. In turn, this information can be used to drive the policies that policy service 316 creates.

Security service 318 is configured to enforce the various policies created and curated by policy service 316 in the network. For example, such policies may be implemented by security service 318 as access control lists (ACLs), firewall rules, or the like, that are distributed to networking equipment 308 for enforcement.

According to various embodiments, architecture 300 may also include asset inventory service 320 that is used to collect information about learned assets/endpoints in network 302 and maintain an inventory of these various devices in network 302. In various embodiments, asset inventory service 320 may do so by embedding sensing modules in networking equipment 308 which passively analyze communications between endpoints. The sensors may use deep packet inspection (DPI) to not only identify the protocols in use by a given packet (e.g., the automation protocol used between HMI 310, controller 306, and SCADA service 314), but also understand the action(s) that are being communicated and to classify both the type of device/component and its application behavior.

For example, when a sensor module executed by networking equipment 308 identifies the use of an automation protocol by a packet, it may examine the payload of each flow to identify any or all of the following:
The device type (e.g., based on passive scan of traffic and matching a known criterion, the device is classified).
The software and/or hardware versions of the device.
MAC and IP addresses of all devices with which the discovered device is communicating.
The activity profile of the device (e.g., how is it trying to communicate), and the protocol(s) it is using.
The commands that are being passed (e.g., SCADA commands, etc.), down to the specific control parameter values.

The sensor modules of networking equipment 308 then then organize the collected information into meaningful tags. In general, these tags are simply a way to categorize devices and their behaviors, similar to the same way a human may look at a pen or a pencil and categorize them as writing instruments. Each device can also have multiple tags associated with it, such as the following:
Component Tags—these tags identify device specific details (e.g., Device ID, SCADA station. PLC, Windows device, etc.).
Activity Tags—these tags identify what the device is doing at the protocol level (Programming CPU, Heartbeat, Emergency Break, Data Push).
User-Defined Tags—these could be custom tags to supply additional context (e.g. “Cell 1 Tag”).
Dynamically Generated Tags—these could be added dynamically (e.g., using ML) to signify whether the behavior of the device is normal or anomalous, or for other dynamic conditions.
Scalable Group Tags—These tags are applied to specific packet flows between a defined group of devices/services in the network. For example, in the case shown. HMI 310, controller 306, and SCADA service 314 may be tagged as belonging to a particular group.

The sensor modules embedded in networking equipment 308 may also collect metadata about the communicating devices/endpoints, including its network identifiers (e.g., IP and MAC addresses), vendor, device-type, firmware version, the switch ID and port where the device is connected, etc. As the sensor module learns details of a new device/endpoint in network 302, it may send its collected metadata about that device, along with its tags, to the asset inventory service 320.

In this manner, asset inventory service 320 may maintain an inventory of each of the endpoint devices in network 302, their associated tags, and their metadata. Thus, as new devices are discovered in network 302, their profile information is added to the live inventory of devices maintained by asset inventory service 320. As noted above, the various tags applied by the sensor modules deployed to networking equipment 308 and used by asset inventory service 320 may be predefined or may, via a user interface (not show) be user-defined.

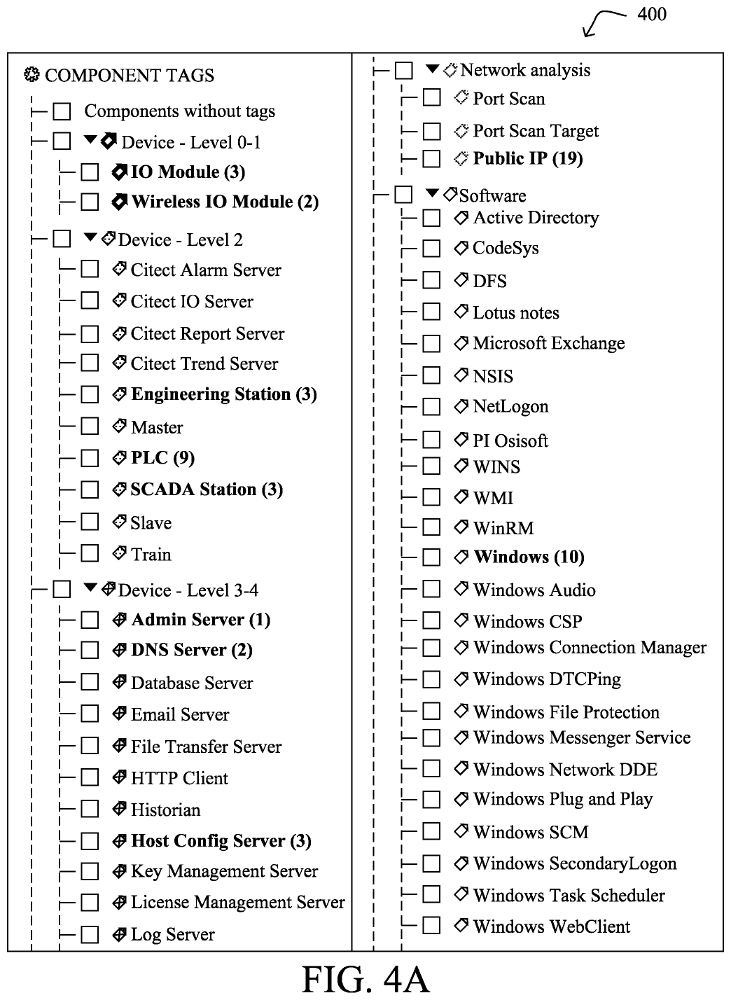

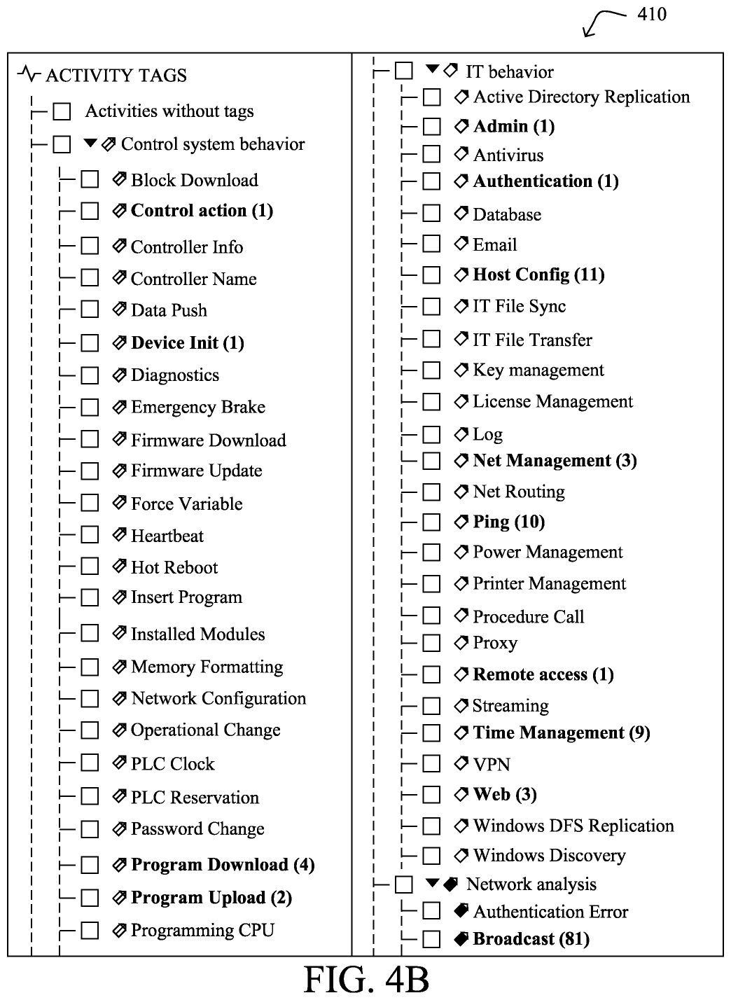

FIGS. 4A-4B illustrate example displays 400, 410, respectively, showing component and activity tags, in some embodiments. As shown, the various component tags can be used to identify a particular endpoint or other device in the network by its type (e.g., PLC, SCADA station, etc.), its software (e.g., CodeSys, Windows, etc.). In addition, analysis of the traffic of the device can also lead to various activity tags being applied to that device, as well. For example, such activity tags may distinguish between control system behaviors (e.g., insert program, device init., etc.) and IT behaviors (e.g., host config., ping, etc.).

Referring again to FIG. 3, to facilitate the labeling of devices in network 302 using tags, asset inventory service 320 may also leverage device classification functions provided by policy service 316, to identify the component and activity tags of a particular device in network 302 under scrutiny. In general, device classification (also known as “device profiling”) has traditionally used static rules and heuristics for the determination. In further embodiments, the device classification by policy service 316 can be achieved by applying a trained machine learning-based classifier to the captured telemetry data from networking equipment 308. Such telemetry data can also take the form of information captured through active and/or passive probing of the device. Notably, this probing may entail policy service 316 sending any or all of the following probes via networking equipment 308:
Dynamic Host Configuration Protocol (DHCP) probes with helper addresses
SPAN probes, to get messages in INIT-REBOOT and SELECTING states, use of ARP cache for IP/MAC binding, etc.
Netflow probes
HyperText Transfer Protocol (HTTP) probes to obtain information such as the operating system (OS) of the device, Web browser information, etc.
Remote Authentication Dial-in User Service (RADIUS) probes.
Simple Network Management Protocol (SNMP) to retrieve Management Information Base (MIB) object or receives traps.
Domain Name System (DNS) probes to get the Fully Qualified Domain Name (FQDN)
etc.

Further information that may be captured by networking equipment 308 and reported via telemetry data to policy service 316 may include traffic behavioral characteristics of the traffic of a device, such as the communication protocols used, flow information, timing and pattern data, and the like. In addition, the telemetry data may be indicative of the operational intent of the endpoint device (e.g., controller 306, HMI 310, etc.).

According to various embodiments, additional information that policy service 316 and asset inventory service 320 may use to tag the various devices/components in network 302 may include any or all of the following:
Manufacturer's Usage Description (MUD) information—As proposed in the Internet Engineering Task Force (IETF) draft entitled, “Manufacturer Usage Description Specification,” devices may be configured by their manufacturers to advertise their device specifications. Such information may also indicate the intended communication patterns of the devices.
Asset Administration Shell data—this is an Industry 4.0 method to express how an IoT device should behave, including expected communication patterns.
IEC 61850 Substation Configuration Language (SCL) data—this is a language that is used primarily in the utility industry to express Intelligent Electronic Device (IED) intent.
Open Platform Communication Unified Architecture (OPC UA) data—such data provides industrial models used in manufacturing contexts.

Thus, policy service 316, asset inventory service 320, and the sensor modules and telemetry exporters of networking equipment 308 may operate in conjunction with one another to apply various tags to the devices in network 302 and their traffic flows.

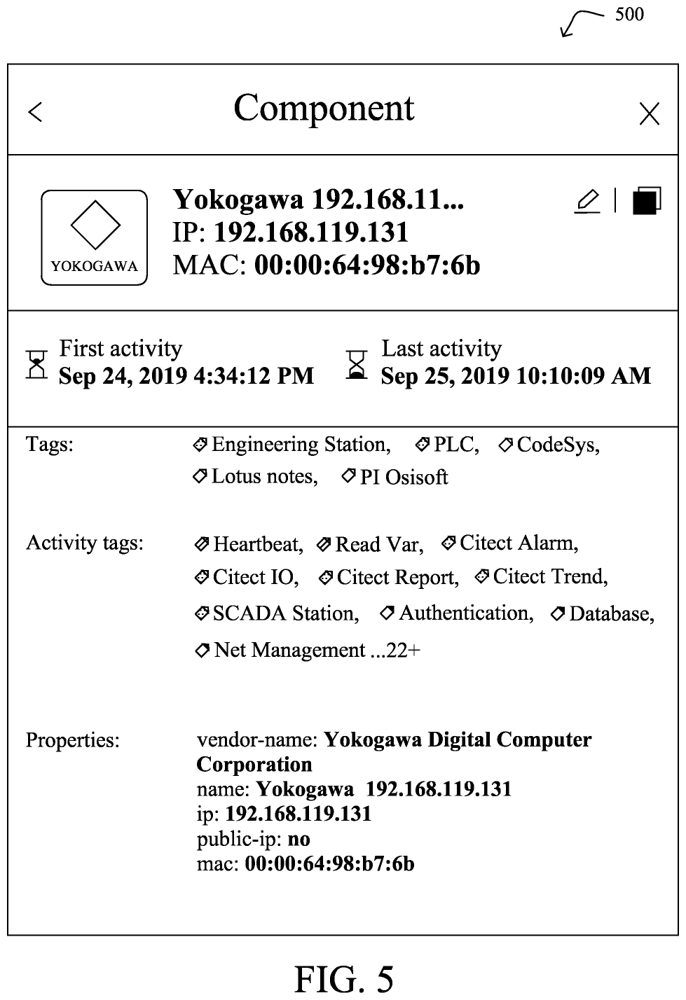

FIG. 5 illustrates an example display 500 of an asset profile, in some embodiments. As can be seen, a particular asset has been identified as a Yokogawa device and has been tagged with various component and activity tags (e.g., PLC, CodeSys, Citect Report, etc.). This profile may be stored by the asset inventory service (e.g., service 320 in FIG. 3) and provide to a user interface, allowing the user to quickly learn information about the device. Such information can also be automatically updated over time, using the techniques herein.

Referring again to FIG. 3, the various tags can also be used to augment flow telemetry, such as Netflow records, IPFIX records, or the like. To do so, asset inventory service 320 may propagate any of its stored tags to a Netflow collector or other telemetry exporter. As would be appreciated, such telemetry exporters typically build flow tables based on Netflow-9 metadata, such as 5-Tuple TCP/IP information, etc. However, such telemetry collectors and analyzers do not understand what the device is or how it should be operating. According to various embodiments, augmenting a telemetry exporter to understand the OT policy and intent of industrial devices allows for better enforcement of the allowed flows in an OT environment, and improves troubleshooting when a cyber incident occurs.

In various embodiments, by tagging the endpoint devices in network architecture 300 in terms of what they are and what they should do, it becomes possible to automatically implement and enforce network policies and to quickly identify security threats. To do so, policy service 316 can be used to authenticate, authorize, and provide policies for specific endpoints and/or user in network 302. Generic elements of such a policy may specify component, activity, or other tags. For example, a generic policy may be created for all PLCs in Cell Area Zone 1. Such a policy may specify a ‘PLC’ component tag, as well as activity tags indicative of what types of activities the PLCs are allowed to perform, what protocols they are allowed to communicate, and with whom they are allowed to communicate. For instance, controller 306 may be allowed to communicate with other industrial devices in the same Cell Area Zone, but not beyond. In another instance, controller 306 may only be allowed to communicate with an HMI in the same zone, such as HMI 310.

Typically, a policy generated by policy service 316 will take the form of a logical combination of tags. For example, one policy may be as follows:
IF the device is a PLC AND is in CELL-1 THEN it may talk to device-x
   When this policy is deployed to networking equipment 308, controller 306 may be allowed to communicate with HMI 310, but may be restricted from communicating with other devices via network 302. Notably, this can even lead to policies that are cell/zone specific in the OT network 302 (e.g., a PLC is restricted from communicating with other devices outside of its cell).

During operation, policy service 316 may receive updates from asset inventory service 320, either periodically or on demand. This allows policy service 316 visibility into all of the discovered devices on the network, along with their tags and other metadata. Preferably, policy service 316 will use the same tag format as that of asset inventory service 320. In turn, policy service 316 may create an entry for the device based on what has been discovered, with specific data updated based on information learned by the sensor in networking equipment 308 (e.g., the telemetry collector/exporter) and given through asset inventory service 320.

By pushing a policy to networking equipment 308, the corresponding networking equipment 308 can enforce the policy by applying it to any traffic flow in network 302. If the traffic flow is then deemed non-compliant, the networking equipment 308 can initiate a corrective measure, such as blocking the flow from reaching its destination, raising an alarm, redirecting the flow, or the like.

Note that, in some cases, it may not be possible for policy service 316 to perform an exact match between a discovered device and an existing policy, through the use of tags alone. In such a situation, policy service 316 may leverage a machine learning classifier (e.g., a neural network or the like) to perform such a matching, using the tags and other metadata information about the device (e.g., its observed communication patterns, etc.). Note also that the deployed sensor(s) in networking equipment 308 can also update the tags for a particular device over time, as well. If this occurs, policy service 316 may re-evaluate the policy assigned to that device.

In some implementations, enforcement of the identified policy can be achieved by passing the policy to security service 318. This can be achieved via application programming interface (API) export or, as noted above, by embedding the assigned tags directly into the telemetry exports that are ingested, parsed, and processed by the security processes of networking equipment 308. In addition, the analyzer can group flows by their expected context, for purposes of visualizations. For instance, such a visualization could show all OT devices that are slaves of a particular SCADA master.

By comparing the flow details that have enhanced with the tag information to the deployed policy, the security mechanism can identify policy violations. For example, OT devices use very prescribed flows, such as SCADA service 314 being restricted to communicating with SCADA endpoints/slaves using a SCADA protocol. If a non-SCADA master is shown to be communicating with a SCADA device, even if the protocol and commands were valid, this would be considered a security violation by the enforcing networking equipment 308 and corrective measures initiated.

Said differently, when a new flow is generated, the telemetry collector/exporter may cross reference the IP address(es) of the new flow entry with the type or definition of the asset, to enhance the flow telemetry. In turn, the analyzer of such telemetry can then assess the tags and security policy assigned to the devices, to enforce the policy.

In further embodiments, the policy enforcement can also rely on behavioral analytics, to identify any behavioral anomalies exhibited by an endpoint device. By tracking and updating the activity tags of a device over time using the above techniques, this effectively creates a baseline behavioral profile for that device. Thus, when its behavior suddenly deviates from its expected activities/behaviors, the analyzing networking equipment 308 can initiate a corrective measure. If a new activity tag is associated with the device, this can be compared with its associated policies, to determine whether this new behavior is still acceptable.

Since activity tags can be learned and updated over time, when a new device appears or disappears on network 302, it may also be assigned a temporal tag to indicate that the device should be scrutinized. For example, if a device tagged as critical disappears from the network, a critical alarm could be raised. Similarly, when a new device suddenly appears on the network, it may be assigned a “new” tag and its behavior monitored to a higher degree and/or have more stringent policies applied to it.

For example, HMI 310 may be allowed to load a new program to controller 306, but if a “new” PLC in network 302 similarly attempts to load a program to controller 306, then an alarm may be triggered.

In one embodiment, the networking equipment 308 enforcing a policy may leverage a Naïve Bayes classifier or other suitable machine learning-based classifier, to determine whether the new device on the network presents a threat. The temporal tags can also be aged out over time, as the device's behavior is deemed normal over a defined period of time and is, thus, trustworthy.

In other words, when either a new endpoint device appears on network 302 or an existing endpoint device begins to operate in a new way (e.g., new tags are added or appear in its traffic flows), the networking equipment 308 enforcing the policies may compute and assess the probability that the endpoint device (and/or its behavior) is either benign or malicious. Data parameters, primarily the component and activity tags, as well as flow characteristics are used as input parameters for this computation. In some embodiments, these data points could also be clustered in an n-dimensional space, to profile both benign and malicious behavior from past events and devices. In turn, a Naïve Bayes classifier could create cluster boundaries for these clusters and classify the endpoint device under scrutiny as either benign or malicious, accordingly.

—SCHC-Based Forwarding Decisions in OT Networks—

As noted above, the nature of the IoT makes network security (and forwarding) particularly challenging, especially in the case of industrial settings, such as factories, mines, ports, power substations, and the like. As also noted above, in industrial/OT networks, in particular, a wide variety of industrial protocols (e.g., Modbus, Profinet, Fieldbus Foundation, etc.) use semi-proprietary formats to convey both control and data packets. The majority of these protocols are evolving towards IP in the so-called “IT/OT convergence”.

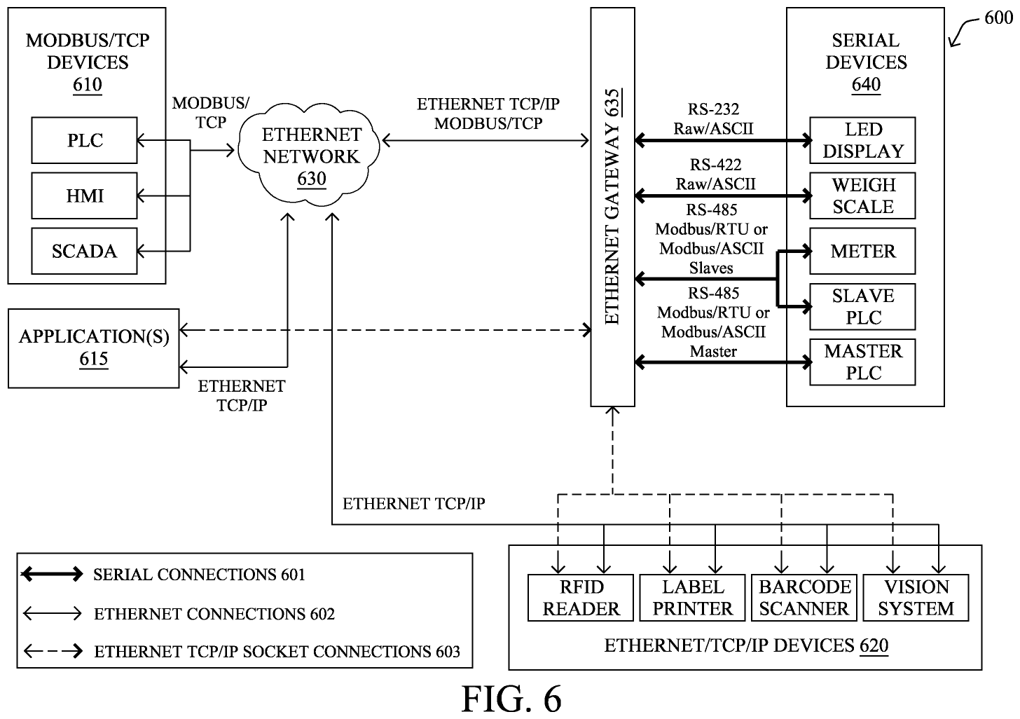

For example, FIG. 6 illustrates another example of an industrial/OT network 600, where devices may communicate over serial connections 601, Ethernet connections 602, and/or Ethernet TCP/IP socket connections 603, as shown. For instance, various “Modbus/TCP devices” 610 (e.g., PLCs, HMIs, SCADAs, etc.) may communicate with Ethernet network 630 over Modbus/TCP connections, while Applications 625 and Ethernet TCP/IP devices 620 (e.g., an RFID reader, a label printer, a barcode scanner, a vision system, and so on) may communicate with Ethernet network 630 over Ethernet TCP/IP connections. Additionally, the Applications 625 and Ethernet TCP/IP devices 620 can also communicate via socket connections with an Ethernet gateway 635, which communicates with serial devices 640 (e.g., an LED display, weigh scale, meter, slave/master PLCs, etc.). (Other configurations of an industrial/OT network may be used herein, and network 600 is merely an example to illustrate a number of diverse components within a single network.)

Understanding wide variety of industrial protocols enables growth in terms of OT-specific functions configured within network routers. For instance, one highly desirable function and yet unmet need in industrial/OT networks, is to be able to differentiate between control messages and data messages, and/or between real-time processes from background processes, and to apply quality of service (QoS) parameters for differentiated services (diffserv), accordingly.

As noted above, intelligent network controllers use deep-packet inspection (DPI) technology for industrial network protocols (such as Cyber Vision available from Cisco Systems, Inc.) to decode instructions sent and received by IoT devices (via industrial protocols) to analyze their behavior, which can be expressed as “Component Tags” (or “asset tags”) and/or “Activity Tags” (e.g., as used by Cyber Vision). These tags, in typical networks (e.g., IPv6 networks) can then be used for forwarding and security within the network. However, the use of such behavioral analytics engines for forwarding and security for constrained networks, such as industrial/OT networks in particular, are hardly suitable for decisions at line rate given the associated complexity and latency.

The techniques herein, therefore, provide for forwarding decisions based on header compression in industrial networks. In particular, the techniques herein may illustratively use a header compression protocol, such as Static Context Header Compression (SCHC), not only as a compression technique, but also particularly as a filter to triage critical packets and assign them to high QoS and deterministic flows, accordingly. Notably, SCHC, in particular, applies in the exact same fashion for IP and non-IP packets, so the techniques herein according to the illustrative SCHC protocol for header compression are applicable to any control network.

Other header compression protocols may be used, and SCHC is merely one particular embodiment used herein. For example, other compression protocols include such things as, e.g., the Robust Header Compression or “RoHC”, IPv6 over Low-Power Wireless Personal Area Networks or “6LoWPAN”, and so on. SCHC, in particular, associates the benefits of the RoHC context, which provides high flexibility in the fields processing, and of the 6LoWPAN operations to avoid transiting fields that are known by the other side.

Specifically, the SCHC engine (IETF RFC 8724, RFC 8824) is used to compress packets on constrained networks such as Low-Power Wide-Area Networks (LPWAN). SCHC is a standard compression and fragmentation mechanism that offers compression and fragmentation of IPv6/UDP/CoAP packets to allow their transmission over the LPWAN, since LPWAN is severely limited in terms of throughput and packet size supported, and LPWAN packets cannot carry IPv6, which was designed to allocate addresses to the billions of IoT connected devices.

SCHC, in particular, compression takes advantage of the LPWAN characteristics (e.g., no routing, highly predictable traffic format and content of messages) to reduce the overhead to a few bytes, and thus save network traffic. The SCHC compression is based on the notion of context. A context is a set of rules that describes the communication context, meaning the header fields. It is shared and pre-provisioned in both the end-devices and the core network. (The “static context” assumes that the rule description does not change during transmission.) Thanks to this mechanism, IPv6/UDP headers are in most cases reduced to a small identifier.

Currently, there is no known use for SCHC for anything else but compression. In contrast, the techniques herein propose a new operation that utilizes SCHC to configure forwarding operations at the edge of an industrial/OT network, in the first hop router or in the end-device stack itself. That is, operationally, the techniques herein delegate the forwarding control/operation to the lower stack in the router by pushing SCHC rules that recognize packet formats (e.g., sets of features) and that allow the router to set differential services (diffserv) “type of service” (or similar) bits/flags/indications within the compressed headers of the packets, accordingly. Additionally, the techniques herein may also select a particular time slot of a time sensitive scheduling communication network (e.g., “6TiSCH”, short for IPv6 over the Time Slotted Channel Hopping (TSCH) mode of IEEE802.15.4e) or a time-sensitive networking (TSN) queue based on a recognized packet. (Note that example types of time sensitive scheduling communication networks may comprise such things as 802.15.4 TSCH, time triggered networks like some 802.1 shapers, Time-Division multiplexed like classical buses, and other time/frequency resource allocation like Wi-Fi 6 RUs and 5G Resource Blocks, among others as will be appreciated by those skilled in the art.)

Specifically, according to one or more embodiments of the techniques herein, an illustrative method of the present disclosure may comprise: receiving, at an access device for a network, a packet having a set of packet features; making, by the access device, a determination that the set of packet features of the packet match a forwarding ruleset that defines differentiated services for different types of packets based on their packet features; formulating, by the access device and based on the determination, a compressed header for the packet that has one or more differentiated service indicators based on the forwarding ruleset; and forwarding, from the access device, the packet with the compressed header, to cause forwarding decisions to be made within the network for the packet based on the one or more differentiated service indicators in its compressed header. In one embodiment, the method further comprises: making, by the access device, a negative determination that the set of packet features of the packet does not match the forwarding ruleset; and sending, by the access device and based on the negative determination, the packet to a network controller for further examination. In still another embodiment, the network controller validates the packet and forwards the packet through the network towards a destination, and the method further comprises: receiving, from the network controller, an update for the forwarding ruleset to include the set of packet features of the packet that did not match the forwarding ruleset.

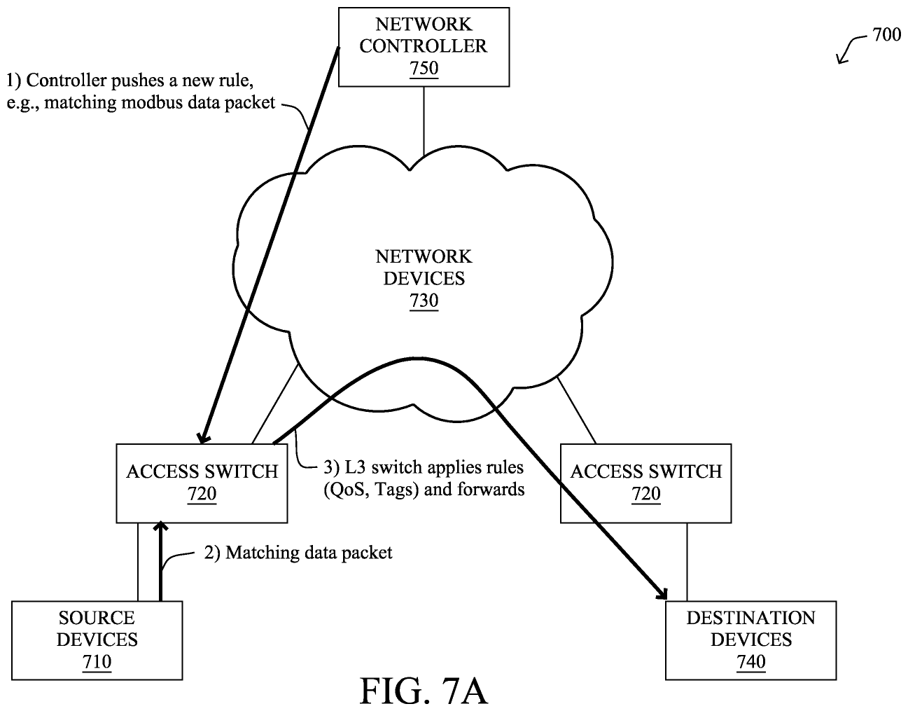

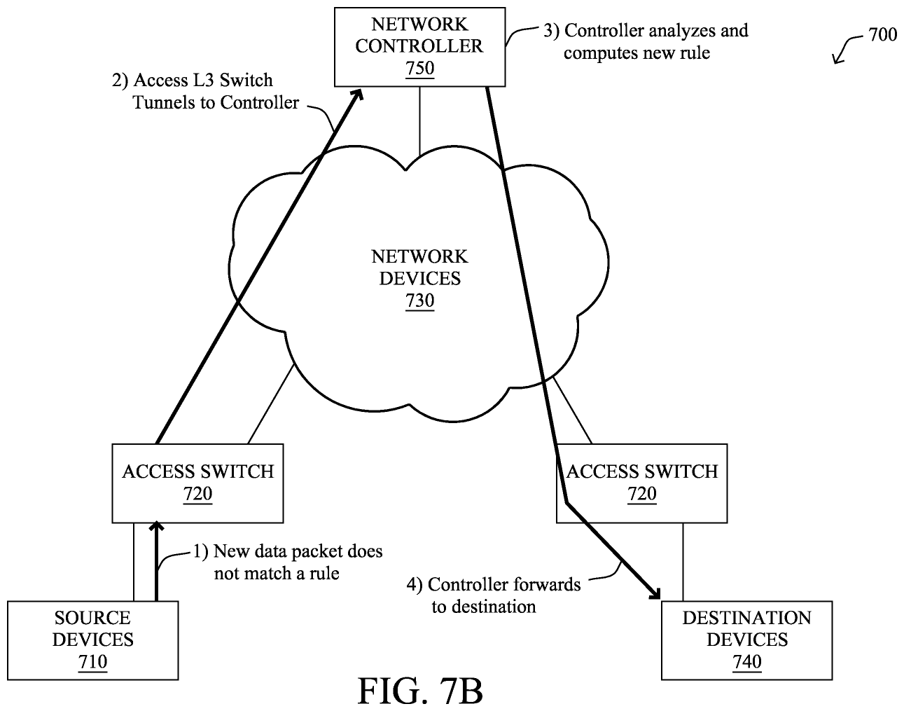

Operationally, and with reference generally to FIGS. 7A-7B showing an example industrial network 700, source devices 710 communicate with the network 700 via an ingress access switch 720 (e.g., an L3 switch, LPWAN gateway, other first hop devices, etc.), through a collection of network devices 730 (e.g., routers, switches, load balancers, etc.) to reach an egress access switch 720 for various destination devices 740.

Illustratively, the techniques herein may also operate in collaboration with a network controller 750, such as a behavioral analytics engine as described above (e.g., Cyber Vision from Cisco Systems, Inc.). The network controller, in particular, may leverage the techniques herein to push forwarding rules to selected routers (access switches 720) based on their locations and which device types are connected to them (devices 710, 740, etc.). The forwarding rules, in particular, may indicate the forwarding treatment for different kinds of packets, e.g., control versus data packets, real-time versus background packets, high-priority versus low priority, and so on. For example, a matching category of data packets may be placed in a TSN queue for deterministic treatment, while some control packets are given network priority as QoS because they control the Modbus operation. Other (default) Modbus packets may be forwarded normally, and non-Modbus packets may be dropped.

Notably, the techniques herein may begin either with a pre-configuration of the access switches 720 and subsequent updating based on “unknown packets”, or else may start fresh to only learn the configuration over time as each new type of packet is received. Note that in either instance, the IETF is now defining a data model for SCHC, with an Internet Draft entitled “Data Model for Static Context Header Compression (SCHC)” (draft-ietf-lpwan-schc-yang-data-model-08), which will allow pushing SCHC rules onto devices. The techniques herein may leverage such a data model to program first hop devices (e.g., an LPWAN gateway) with the forwarding functions defined herein while compressing LPWAN packets, accordingly.

In particular, with reference to FIG. 7A, the network controller 750 (e.g., behavioral analytics engine/Cyber Vision) may program first hop devices (access switches 720, LPWAN gateways, etc.) [step 1] with header compression rules (e.g., SCHC rules) to control forwarding within the network 700 (through network devices 730) using bits/flags/indications within the compressed headers of the packets, as mentioned above. That is, the first hop devices are thus trained to recognize certain packet formats (e.g., sets of features, such as Modbus data packets, control packets, etc.), such that they can initiate/direct the required differential services (diffserv) through the network, (e.g., type of service or “TOS” or similar treatments), accordingly. Thereafter, when a matching packet comes into the ingress access switch 720 [step 2], then the L3 switch applies the corresponding rule (e.g., QoS, tags, etc.) and forwards the recognized packet to the destination device(s) 740 through the network [step 3] with the appropriate header-compression-based forwarding decisions being made throughout the network 700 (e.g., network devices 730).

Turning now to FIG. 7B, whenever a new packet is received that does not match a currently stored rule at the first hop access switch 720 [step 1], i.e., an “unknown” (or “unrecognized”) packet, the access switch may tunnel this unknown packet to the network controller 750 [step 2] for further examination. The network controller analyzes the unknown packet [step 3] to create a new rule by determining a protocol (e.g., Modbus) and whether the packet is valid/expected. If valid, then the controller forwards the packet to the normal destination [step 4], e.g., destination devices 740 via their associated egress access switch 720. (If the unknown packet was invalid, it may be dropped, or otherwise handled, accordingly.)

Referring back to FIG. 7A, concurrent with (or subsequent to) managing the previously unknown packet, the network controller 750 pushes updated SCHC rules that match the previously unknown packet to the source of the tunneled packet (e.g., the ingress access switch 720) [step 1]. Thereafter, that type of packet would be recognized by the ingress access switch, and would be handled accordingly (e.g., forwarding with associated header compression as defined herein, or else dropping the packet if invalid).

Note that in one embodiment herein, where packets that match the rules are not typically encapsulated/tunneled and sent to the network controller 750, samples may occasionally be sent to the controller (e.g., only to the network controller or else in combination with also being forwarded directly to the destination) for continuous learning, confirmation, and so on.

Furthermore, in another variation herein, all packets, recognized or unknown, are always sent directly to the destination devices, but copies of unknown packets are sent to the network controller 750 for examination. In this manner, the enhanced processing is not the only pathway for the initial unknown packets, enabling a faster start for a new network or new type of packet, but with the tradeoff of having lower security barriers (e.g., reacting after one or more unknown packets have already reached the destination, rather than before any security breach could possibly occur).

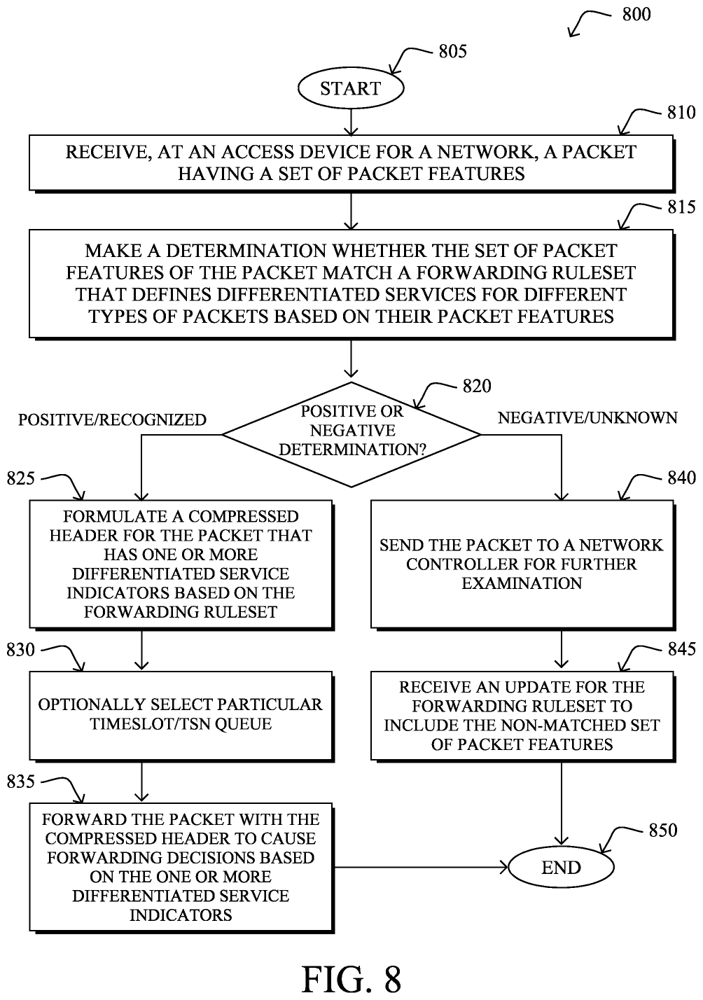

In closing, FIG. 8 illustrates an example simplified procedure 800 for enabling forwarding decisions based on header compression in industrial networks in accordance with one or more embodiments described herein. For example, a non-generic, specifically configured device (e.g., device 200, e.g., access L3 switch, industrial gateway, etc.) may perform procedure 800 by executing stored instructions (e.g., process 248). The procedure 800 may start at step 805, and continues to step 810, where, as described in greater detail above, an access device (e.g., L3 switch, LPWAN gateway, etc.) for a network (e.g., an OT network) receives a packet having a set of packet features.

In step 815, the access device makes a determination whether the set of packet features of the packet match a forwarding ruleset that defines differentiated services for different types of packets based on their packet features. As noted above, the forwarding ruleset may have been received from a network controller, and may define differentiated services for different types of packets based on their packet features corresponding to being either a control packet or a data packet, being either a real-time process packet or a background process packet, and so on. The forwarding ruleset may also define dropping certain types of packets based on their packet features. (Note, too, that the forwarding ruleset may be specific to the access device based on one or more factors of the access device, such as a location of the access device, types of connected devices, a type of device of the access device, and so on.)

If the determination is positive in step 820 (i.e., there is a match and the packet is recognized), then in step 825 the access device formulates a compressed header for the packet that has one or more differentiated service indicators based on the forwarding ruleset, and optionally (e.g., for a time sensitive scheduling communication network such as 6TiSCH or for a TSN) in step 830 selects a particular timeslot or TSN queue for the packet based on the forwarding ruleset. Then, in step 835, the access device forwards the packet with the compressed header, to cause forwarding decisions to be made within the network for the packet based on the one or more differentiated service indicators in its compressed header (e.g., and based on the particular timeslot/TSN queue).

If, on the other hand, the determination is negative in step 820 (i.e., there is no match and the packet is unrecognized/unknown), then in step 840 the access device sends (e.g., tunnels) the packet to a network controller for further examination, as detailed above. For instance, the network controller may then validate the packet and forward the packet through the network towards a destination, and in step 845 the access device may receive, from the network controller, an update for the forwarding ruleset to include the set of packet features of the packet that did not match the forwarding ruleset (e.g., for applying differentiated services within a compressed header, or simply to drop future packets with that set of features.

The simplified procedure 800 may then end in step 850, notably with the option to continue receiving further packets (recognized or unrecognized), further rule updates, and so on. Other steps may also be included generally within procedure 800. For example, such steps (or, more generally, such additions to steps already specifically illustrated above), may include: forwarding, by the access device and based on the negative determination, the packet through the network towards a destination in addition to sending the packet to the network controller; sending, by the access device and based on the determination, the packet to a network controller for sampled examination in addition to forwarding the packet with the compressed header; and so on. In addition, in one embodiment, such steps may include, e.g., in addition to (parallel to) sending the packet to the network controller for further examination: making, by the access device, a negative determination that the set of packet features of the packet does not match the forwarding ruleset; formulating, by the access device and based on the negative determination, a basic compressed header for the packet without differentiated service indicators; and forwarding, from the access device, the packet with the basic compressed header, to cause forwarding decisions to be made within the network for the packet based on the basic compressed header without differentiated service indicators.

It should be noted that while certain steps within procedure 800 may be optional as described above, the steps shown in FIG. 8 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide for forwarding decisions based on header compression in industrial networks. In particular, automation technologies are rapidly advancing toward deterministic networking (DetNet) as well as time-sensitive networking (TSN). At the same time, industrial switching hardware needs to recognize and process legacy protocols. The techniques herein may thus be embedded into switches to sort out packets and assign QoS parameters, accordingly (e.g., assigning time-sensitive packets to TSN flows, and so on). As described above, this may be achieved by pushing a SCHC rule to drive forwarding decisions (including TSN slot/queue selection/etc.). Moreover, whenever an unknown packet is encountered, provisions are provided for sending that packet to an analysis engine for further processing (e.g., as an intermediary for ultimate security, or as a parallel process for “after the fact adjustment” security, as mentioned above).

Illustratively, the techniques described herein may be performed by hardware, software, and/or firmware, such as in accordance with the illustrative header compression process 248, which may include computer executable instructions executed by the processor 220 to perform functions relating to the techniques described herein, e.g., in conjunction with corresponding processes of other devices in the computer network as described herein (e.g., forwarding process 244 of other network devices, header compression process 248 of a behavioral analytics engine, etc.). In addition, the components herein may be implemented on a singular device or in a distributed manner, in which case the combination of executing devices can be viewed as their own singular “device” for purposes of executing the process 248.

According to the embodiments herein, an illustrative method herein may comprise: receiving, at an access device for a network, a packet having a set of packet features; making, by the access device, a determination that the set of packet features of the packet match a forwarding ruleset that defines differentiated services for different types of packets based on their packet features; formulating, by the access device and based on the determination, a compressed header for the packet that has one or more differentiated service indicators based on the forwarding ruleset; and forwarding, from the access device, the packet with the compressed header, to cause forwarding decisions to be made within the network for the packet based on the one or more differentiated service indicators in its compressed header.

In one embodiment, the method further comprises: making, by the access device, a negative determination that the set of packet features of the packet does not match the forwarding ruleset; and sending, by the access device and based on the negative determination, the packet to a network controller for further examination. In one embodiment, the network controller validates the packet and forwards the packet through the network towards a destination, and the method further comprises: receiving, from the network controller, an update for the forwarding ruleset to include the set of packet features of the packet that did not match the forwarding ruleset. In one embodiment, the method further comprises: forwarding, by the access device and based on the negative determination, the packet through the network towards a destination in addition to sending the packet to the network controller.

In one embodiment, the method further comprises: receiving the forwarding ruleset from a network controller.

In one embodiment, the method further comprises: sending, by the access device and based on the determination, the packet to a network controller for sampled examination in addition to forwarding the packet with the compressed header.

In one embodiment, the forwarding ruleset is specific to the access device based on one or more factors of the access device selected from a group consisting of: a location of the access device; types of devices connected to the access device; and a type of device of the access device.

In one embodiment, the forwarding ruleset defines differentiated services for different types of packets based on their packet features corresponding to being either a control packet or a data packet.

In one embodiment, the forwarding ruleset defines differentiated services for different types of packets based on their packet features corresponding to being either a real-time process packet or a background process packet.

In one embodiment, the forwarding ruleset defines dropping certain types of packets based on their packet features.

In one embodiment, the method further comprises: making, by the access device, a negative determination that the set of packet features of the packet does not match the forwarding ruleset; formulating, by the access device and based on the negative determination, a basic compressed header for the packet without differentiated service indicators; and forwarding, from the access device, the packet with the basic compressed header, to cause forwarding decisions to be made within the network for the packet based on the basic compressed header without differentiated service indicators.

In one embodiment, the network is an operational technology network.

In one embodiment, the network is a time sensitive scheduling communication network, and the method further comprises: selecting, by the access device and based on the determination, a particular timeslot in the time sensitive scheduling communication network for the packet based on the forwarding ruleset, wherein forwarding the packet is based on the particular timeslot.

In one embodiment, the network is based on time-sensitive networking, and the method further comprises: selecting, by the access device and based on the determination, a particular time-sensitive networking queue for the packet based on the forwarding ruleset, wherein forwarding the packet is based on the particular time-sensitive networking queue.

According to the embodiments herein, an illustrative tangible, non-transitory, computer-readable medium herein may have computer-executable instructions stored thereon that, when executed by a processor on a computer, may cause the computer to perform a method comprising: receiving, as an access device for a network, a packet having a set of packet features; making a determination that the set of packet features of the packet match a forwarding ruleset that defines differentiated services for different types of packets based on their packet features; formulating, based on the determination, a compressed header for the packet that has one or more differentiated service indicators based on the forwarding ruleset; and forwarding the packet with the compressed header, to cause forwarding decisions to be made within the network for the packet based on the one or more differentiated service indicators in its compressed header. In one embodiment, the method further comprises: making a negative determination that the set of packet features of the packet does not match the forwarding ruleset; and sending, based on the negative determination, the packet to a network controller for further examination. In one embodiment, the network controller validates the packet and forwards the packet through the network towards a destination, and the method further comprises: receiving, from the network controller, an update for the forwarding ruleset to include the set of packet features of the packet that did not match the forwarding ruleset.

Further, according to the embodiments herein an illustrative apparatus herein may comprise: a processor configured to execute one or more processes; and a memory configured to store a process that is executable by the processor, the process, when executed, configured to: receive, as an access device for a network, a packet having a set of packet features; make a determination that the set of packet features of the packet match a forwarding ruleset that defines differentiated services for different types of packets based on their packet features; formulate, based on the determination, a compressed header for the packet that has one or more differentiated service indicators based on the forwarding ruleset; and forward the packet with the compressed header, to cause forwarding decisions to be made within the network for the packet based on the one or more differentiated service indicators in its compressed header. In one embodiment, the process, when executed, is further configured to: make a negative determination that the set of packet features of the packet does not match the forwarding ruleset; send, based on the negative determination, the packet to a network controller for further examination; and receive, from the network controller in response to the network controller validating the packet, an update for the forwarding ruleset to include the set of packet features of the packet that did not match the forwarding ruleset.

While there have been shown and described illustrative embodiments above, it is to be understood that various other adaptations and modifications may be made within the scope of the embodiments herein. For example, while certain embodiments are described herein with respect to certain types of networks in particular, the techniques are not limited as such and may be used with any computer network, generally, in other embodiments. Moreover, while specific technologies, protocols, and associated devices have been shown, other suitable technologies, protocols, and associated devices may be used in accordance with the techniques described above. In addition, while certain devices are shown, and with certain functionality being performed on certain devices, other suitable devices and process locations may be used, accordingly. That is, the embodiments have been shown and described herein with relation to specific network configurations (orientations, topologies, protocols, terminology, processing locations, etc.). However, the embodiments in their broader sense are not as limited, and may, in fact, be used with other types of networks, protocols, and configurations.

Moreover, while the present disclosure contains many other specifics, these should not be construed as limitations on the scope of any embodiment or of what may be claimed, but rather as descriptions of features that may be specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

For instance, while certain aspects of the present disclosure are described in terms of being performed “by a server” or “by a controller” or “by a provider”, those skilled in the art will appreciate that other modules, components, and/or agents may be considered to be extensions of the gateway/controller/manager operation, and as such, any process step performed “by a device” need not be limited to local processing on a specific device, unless otherwise specifically noted as such.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

1. A method, comprising:
receiving, at an access device for a network, a packet having a set of packet features;
making, by the access device, a determination that the set of packet features of the packet match a forwarding ruleset that defines differentiated services for different types of packets based on their packet features;
formulating, by the access device and based on the determination, a compressed header for the packet that has one or more differentiated service indicators based on the forwarding ruleset; and
forwarding, from the access device, the packet with the compressed header, to cause forwarding decisions to be made within the network for the packet based on the one or more differentiated service indicators in its compressed header.

2. The method as in claim 1, further comprising:
making, by the access device, a negative determination that the set of packet features of the packet does not match the forwarding ruleset; and
sending, by the access device and based on the negative determination, the packet to a network controller for further examination.

3. The method as in claim 2, wherein the network controller validates the packet and forwards the packet through the network towards a destination, the method further comprising:
receiving, from the network controller, an update for the forwarding ruleset to include the set of packet features of the packet that did not match the forwarding ruleset.

4. The method as in claim 2, further comprising:
forwarding, by the access device and based on the negative determination, the packet through the network towards a destination in addition to sending the packet to the network controller.

5. The method as in claim 1, further comprising:
receiving the forwarding ruleset from a network controller.

6. The method as in claim 1, further comprising:
sending, by the access device and based on the determination, the packet to a network controller for sampled examination in addition to forwarding the packet with the compressed header.

7. The method as in claim 1, wherein the forwarding ruleset is specific to the access device based on one or more factors of the access device selected from a group consisting of: a location of the access device; types of devices connected to the access device; and a type of device of the access device.

8. The method as in claim 1, wherein the forwarding ruleset defines differentiated services for different types of packets based on their packet features corresponding to being either a control packet or a data packet.

9. The method as in claim 1, wherein the forwarding ruleset defines differentiated services for different types of packets based on their packet features corresponding to being either a real-time process packet or a background process packet.

10. The method as in claim 1, wherein the forwarding ruleset defines dropping certain types of packets based on their packet features.

11. The method as in claim 1, further comprising:
making, by the access device, a negative determination that the set of packet features of the packet does not match the forwarding ruleset;
formulating, by the access device and based on the negative determination, a basic compressed header for the packet without differentiated service indicators; and
forwarding, from the access device, the packet with the basic compressed header, to cause forwarding decisions to be made within the network for the packet based on the basic compressed header without differentiated service indicators.

12. The method as in claim 1, wherein the network is an operational technology network.

13. The method as in claim 1, wherein the network is a time-sensitive scheduling communication network, the method further comprising:
selecting, by the access device and based on the determination, a particular timeslot in the time sensitive scheduling network for the packet based on the forwarding ruleset, wherein forwarding the packet is based on the particular timeslot.

14. The method as in claim 1, wherein the network is based on time-sensitive networking, the method further comprising:
selecting, by the access device and based on the determination, a particular time-sensitive networking queue for the packet based on the forwarding ruleset, wherein forwarding the packet is based on the particular time-sensitive networking queue.

15. A tangible, non-transitory, computer-readable medium having computer-executable instructions stored thereon that, when executed by a processor on a computer, cause the computer to perform a method comprising:
receiving, as an access device for a network, a packet having a set of packet features;
making a determination that the set of packet features of the packet match a forwarding ruleset that defines differentiated services for different types of packets based on their packet features;
formulating, based on the determination, a compressed header for the packet that has one or more differentiated service indicators based on the forwarding ruleset; and
forwarding the packet with the compressed header, to cause forwarding decisions to be made within the network for the packet based on the one or more differentiated service indicators in its compressed header.

16. The tangible, non-transitory, computer-readable medium as in claim 15, wherein the method further comprises:
making a negative determination that the set of packet features of the packet does not match the forwarding ruleset; and
sending, based on the negative determination, the packet to a network controller for further examination.

17. The tangible, non-transitory, computer-readable medium as in claim 16, wherein the network controller validates the packet and forwards the packet through the network towards a destination, and wherein the method further comprises:
receiving, from the network controller, an update for the forwarding ruleset to include the set of packet features of the packet that did not match the forwarding ruleset.

18. The tangible, non-transitory, computer-readable medium as in claim 16, wherein the method further comprises:
forwarding, based on the negative determination, the packet through the network towards a destination in addition to sending the packet to the network controller.

19. An apparatus, comprising:
a processor configured to execute one or more processes; and
a memory configured to store a process that is executable by the processor, the process, when executed, configured to:
receive, as an access device for a network, a packet having a set of packet features;
make a determination that the set of packet features of the packet match a forwarding ruleset that defines differentiated services for different types of packets based on their packet features;
formulate, based on the determination, a compressed header for the packet that has one or more differentiated service indicators based on the forwarding ruleset; and
forward the packet with the compressed header, to cause forwarding decisions to be made within the network for the packet based on the one or more differentiated service indicators in its compressed header.

20. The apparatus as in claim 19, wherein the process, when executed, is further configured to:
make a negative determination that the set of packet features of the packet does not match the forwarding ruleset;
send, based on the negative determination, the packet to a network controller for further examination; and
receive, from the network controller in response to the network controller validating the packet, an update for the forwarding ruleset to include the set of packet features of the packet that did not match the forwarding ruleset.
